(19) United States
(12) Patent Application Publication
(10) Pub. No.: US 2005/0189468 A1
(43) Pub. Date: Sep. 1, 2005

(54) Armor member, retaining member, and image forming apparatus

(76) Inventors: Kazunori Saito, Kanagawa (JP); Shunji Kawashima, Kanagawa (JP)

Correspondence Address: MORGAN & FINNEGAN, L.L.P., 3 WORLD FINANCIAL CENTER, NEW YORK, NY, 10281-2101, US

(21) Appl. No.: 10/513,267

(22) PCT Filed: May 13, 2003
(86) PCT No.: PCT/JP03/05934

§ 371 Date: Nov. 2, 2004

(51) Int. Cl. B32B 15/08; F16F 15/02

(52) U.S. Cl. 248/682

(57) ABSTRACT

There is disclosed are an armor member and a retaining member in which an intermediate member formed of a pulp material or a foamed material is arranged between a plurality of metal members, whereby it is possible for the armor cover member and the retaining member of an image forming apparatus, such as a copying machine or a printer, to achieve a reduction in weight, an improvement in vibration absorbing property, and a reduction in production cost and to cope with the requirements regarding recycling and emission electromagnetic noise while maintaining the requisite rigidity.

### TECHNICAL FIELD

The present invention relates to an armor component and a retaining member for an image forming apparatus, such as a copying machine or a printer.

### BACKGROUND ART

Conventionally, a metal member obtained through stamping of a metal material is used for an armor member for use in an office machine such as a copying machine or a printer and for a retaining member for retaining a scanning optical device (scanner unit) or the like inside a copying machine, a printer or the like. Further, as is known in the art, a resin member formed through injection molding of a resin material is used an armor member.

Regarding the armor member, there is a demand for quality assurance, such as assurance of strength, vibration isolation, acoustic insulation, and electromagnetism shielding from the viewpoint of maintaining the functions of the component units inside the copying machine, printer or the like. Regarding the retaining member also, there is a similar demand for quality assurance, such as assurance of strength and vibration isolation from the viewpoint of retaining a component having a drive source for a scanner or the like. Further, recently, it has become necessary, from the viewpoint of eco-friendliness, to take into account the necessity to facilitate the recycling of apparatuses. Thus, when it is necessary to dispose of a copying machine, printer or the like because of functional renewal, failure or the like, the armor member and the retaining member should have a structure that readily allows dismantling, separation, reuse, etc.

Regarding an armor member made of a metal member, Japanese Patent Application Laid-Open No. 8-101546 discloses a member, which is obtained by coating the surface of a galvanized steel plate with chromate. According to the disclosure, the member is light in weight, highly rigid, superior in slidability relative to other members, and satisfactory in electromagnetism shielding property.

Further, regarding an armor member constructed of an injection-molded product obtained from a resin material, Japanese Patent Application Laid-Open No. 2000-235396 discloses use of such a member as the armor member for an image forming apparatus such as a facsimile apparatus or a laser printer or some other office automation apparatus or a household electrical appliance. Further, according to the disclosure, the armor member has a duplex structure constructed of an inner member and an outer member, and ribs are provided between them to define a plurality of tightly closed spaces. The technique disclosed helps to reduce noise and to increase the rigidity of the armor member. Further, recycling of the member is made possible through formation using the same resin.

On the other hand, regarding the retaining member, various contrivances for assurance of quality have been made, including an increase in the wall thickness of the retaining member itself and provision of a vibration insulating member between the retaining member and the component to be retained. By way of example, a case will be described in which a scanning optical device is retained by a retaining member.

FIG. 1a is a side sectional view of a typical scanning optical device 110, and FIG. 19 is a top plan view thereof. In the drawings, reference numeral 111 indicates a case serving as the casing of the scanning optical device. Numeral 112 indicates a laser light source for emitting a laser beam 113. Numeral 114 indicates a reflection mirror. The laser beam 113 reflected by the reflection mirror 114 is reflected while being deflected by each surface of a polygon 115. Numeral 116 indicates a polygon motor for rotating the polygon 115 at high speed. Numeral 117 indicates an image formation lens unit constructed of a toric lens or the like for effecting image formation out of the laser beam 113 deflected by the polygon 115. The laser beam 113 transmitted through the image formation lens unit 117 is reflected by an elongated reflection mirror 118., and is guided to a photosensitive drum (not shown) arranged below the scanning optical device 110.

The scanning optical device 110 is inevitably subject to generation of a certain vibration since the polygon motor 116 serving as the drive source normally rotates at a high speed ranging from 20,000 rpm to 30,000 rpm. This vibration is transmitted to the lens unit 117, the reflection mirrors 114 and 118, etc. through the case 111. Further, the vibration is also transmitted to the photosensitive drum, and other components of the image forming apparatus main body through the retaining member retaining the scanning optical device 110, thus constituting a great obstruction to an improvement in the image quality of the image forming apparatus. Further, apart from the vibration generated in the scanning optical device 110, vibrations generated by motors for driving a transport roller, a transfer roller, etc. arranged in the image forming apparatus are transmitted to the scanning optical device 110 through the retaining member, which can impair the image quality of the image forming apparatus.

Accordingly, up to now, as shown in FIG. 20, the above-mentioned problem has been coped with by increasing the thickness of the retaining member 121, which is a steel plate retaining the scanning optical device 110, to thereby increase the rigidity of the retaining member. In FIG. 20, the components that are the same as those of FIG. 18 are indicated by the same reference numerals, and a description of such components will be omitted. By increasing the rigidity of the retaining member 121, it is possible to shift the resonance frequency of the retaining member 121 to a higher range, making it possible to prevent the vibration peak appearing in the range of 100 Hz to 400 Hz, which is a frequency band critical in terms of image displacement.

Further, according to Japanese Patent Application Laid-Open No. 11-125789, a vibration-isolating member 132 is provided between the scanning optical device 110 and a metal retaining member 131, as shown in FIG. 21, whereby attenuation of the vibration is achieved. Note that in FIG. 21, the components which are the same as those of FIG. 18 are indicated by the same reference numerals, and a description of such components will be omitted. The vibration-isolating member 132 absorbs the vibration generated in the scanning optical device 110 and the vibration from outside the scanning optical device 110, restraining the vibration. of the scanning optical device 110 in all the frequency bands.

However, in the case of the armor member made of a metal member as disclosed in Japanese Patent Application Laid-Open No. 8-101546, a certain degree of thickness is required in order to ensure a predetermined strength, resulting in a considerable increase in weight, which is a great obstruction to a reduction in apparatus weight. It might be possible to achieve a reduction in weight by adopting a hollow metal member. However, in the case of a flat armor member, this would make it difficult to ensure the requisite rigidity. Further, it might be possible to provide ribs or the like to ensure rigidity. However, in the case of a large armor member for an apparatus with a large volume such as a copying machine or a printer, working the member into such a complicated shape would take much time and effort, resulting in a very poor productivity. Further, such working leads to high cost, resulting in a rather expensive product.

In the case of the resin armor member as disclosed in Japanese Patent Application Laid-Open No. 2000-235396, the resin material undergoes a considerable deterioration in function when reproduced. Further, in many cases, a reproduced resin material is more expensive than a new one, so that it is not suitable for recycling.

Further, there are strict regulations on armor members in terms of flame resistance to temperature. In the case of a resin member, it is necessary to take various measures, such as performing some sort of processing on the surface, addition of other material to the resin material or previous selection of a flame-resistant resin material.

Further, recently, various components contained in an image forming apparatus have electric circuits to be driven at very high frequency, and the emitted electromagnetic wave noise from the circuit boards presents a problem. When a resin member is adopted as the armor member of an image forming apparatus, the emitted electromagnetic wave noise is radiated as it is to the exterior of the armor member, resulting in a serious problem. In a known method for coping with the emitted electromagnetic wave noise, a noise filter constructed of a coil, a capacitor or the like for suppressing emitted electromagnetic wave noise is arranged on each circuit board. However, the emitted electromagnetic wave noise generation mechanism is very complicated, and it is impossible to perfectly cope with the noise with the noise filter alone. Further, since the noise filter has to be provided separately, the circuit board becomes rather expensive.

Regarding the retaining member, it is necessary to take into account the recent increase in the operational speed of image forming apparatuses, such as copying machines and printers, with the RPM of the polygon motor and other driving motors having been increased dramatically. Thus, the influence of the vibration of the polygon motor, etc. on the scanning optical device has been further increased.

However, in the system shown in FIG. 20, in which the thickness of the retaining member 121 is increased for higher rigidity, it is necessary to further increase the thickness of the retaining member 121 when the RPM of the polygon motor 116 increases. As a result, the weight of the retaining member 121 is substantially increased, which leads to a serious obstruction in terms of the designing of the image forming apparatus. Further, the increase in the weight of the member makes the handling thereof during production difficult. While it is possible to use a light and highly rigid metal member, it is not suitable for use in an image forming apparatus due to its high cost.

In the system shown in Japanese Patent Application Laid-Open No. 11-125789, in which the retaining member 131 and the vibration-insulating member 132 are used, the vibration-insulating member 132 is arranged between the metal retaining member 131 and a resin member. In an ordinary vibration damping structure, a vibration absorbing function is exhibited by sandwiching a soft member between hard members. In Japanese Patent Application Laid-Open No. 11-125789, however, one of the members used for the sandwiching is a resin member, which is much softer than a metal plate, so that it is impossible to obtain a sufficient vibration absorbing property. Further, when placing the scanning optical device 110 on the retaining member 131 for assembly, it is necessary to arrange the vibration-isolating member 132 between them. Thus, it is necessary to make allowance for the space for arranging the vibration-isolating member 132 in advance, which leads to a great constraint in terms of product design. Further, the production process involved is very complicated, resulting in an increase in production cost.

### DISCLOSURE OF THE INVENTION

It is an object of the present invention to attain quality assurance, such as assurance of strength, vibration isolation, acoustic insulation, and electromagnetism shielding regarding an armor member for maintaining the function of component units in a copying machine, a printer or the like, and retaining member for retaining a component having a drive source for a scanner or the like. Further, the present invention aims to provide an armor member and a retaining member, which readily allow dismantling, separation and reuse, and which readily make it possible to recycle an apparatus.

In order to achieve the above-mentioned object, according to the present invention, there is provided an armor member including: at least two metal members; and an intermediate member formed of a pulp material or a foamed material, in which the intermediate member is sandwiched between the metal members.

Further, according to the present invention, there is provided an armor member, in which the intermediate member has a base plate member and a plurality of partition members provided on the base plate member, with the base plate member and the partition members defining a plurality of hollow portions between the metal members.

Further, according to the present invention, there is provided an armor member, in which the intermediate member is formed by at least one frame member, which defines a hollow portion between the plurality of metal members.

Further, according to the present invention, there is provided an armor member, in which the metal members have a thickness of 0.3 mm or more.

Further, according to the present invention, there is provided an armor member, in which at least one of the plurality of metal members has at a forward end portion thereof a bent portion, and is fixed to the other metal member by performing a curling process on the bent portion with the intermediate member sandwiched therebetween.

Further, according to the present invention, there is provided an image forming apparatus having the armor member.

Further, according to the present invention, there is provided a retaining member including: at least two metal members; and an intermediate member formed of a pulp material or a foamed material, in which the intermediate member is sandwiched between the metal members.

Further, according to the present invention, there is provided a retaining member, in which the intermediate member has a thickness larger than a thickness of a space defined by the metal members, and is sandwiched between said metal members in a compressed state.

Further, according to the present invention, there is provided a retaining member, in which the thickness of the intermediate member is larger than the thickness of the space defined by the metal members by 0.5 mm or more.

Further, according to the present invention, there is provided an image forming apparatus in which a scanning optical device is retained by the retaining member.

The above and other objects of the Invention will become more apparent from the following drawings taken in conjunction with the accompanying drawings.

### BRIEF DESCRIPTION OF THE DRAWINGS

FIG. 1 is a developed view of an armor cover member according to a first embodiment of the present invention.

FIG. 2 is a sectional view of the armor cover member shown in FIG. 1 taken along the line 2-2.

FIG. 3 is an explanatory view illustrating the operation prior to curling process.

FIG. 4 is an explanatory view illustrating the operation during curling process.

FIG. 5 is an enlarged view of portion A in FIG. 4 during curling process.

FIG. 6 is a diagram showing experiment results indicating the noise characteristics of the first embodiment of the present invention.

FIG. 7 is an explanatory view of a partition member of another configuration.

FIG. 8 is an explanatory view of a partition member of still another configuration.

FIG. 9 is an explanatory view of a partition member of yet another configuration.

FIG. 10 is a sectional view of a retaining member prior to assembly.

FIG. 11 is a sectional view of the retaining member assembled.

FIG. 12 is a perspective view of the retaining member assembled.

FIG. 13 is a sectional view showing how a scanning optical device is retained by the retaining member.

FIG. 14 is a perspective view illustrating an experiment method in Experimental Example 2 of the present invention.

FIG. 15 is a graph showing the vibration characteristics of the retaining member of Experimental Example 2 of the present invention.

FIG. 16 is a graph showing the vibration characteristics of the retaining member of Comparative Example 4 of the present invention.

FIG. 17 is a graph showing the vibration characteristics obtained with the retaining member and the vibration-insulating member of Comparative Example 5 of the present invention.

FIG. 18 is a sectional view showing the construction of a typical scanning optical device.

FIG. 19 is a plan view showing the construction of the typical scanning optical device.

FIG. 20 is a sectional view showing how a scanning optical device is retained by a conventional retaining member.

FIG. 21 is a sectional view showing how a scanning optical device is retained by a conventional retaining member and vibration-insulating member.

### BEST MODE FOR CARRYING OUT THE INVENTION

Embodiments of the present invention will now be described with reference to the drawings.

(First Embodiment)

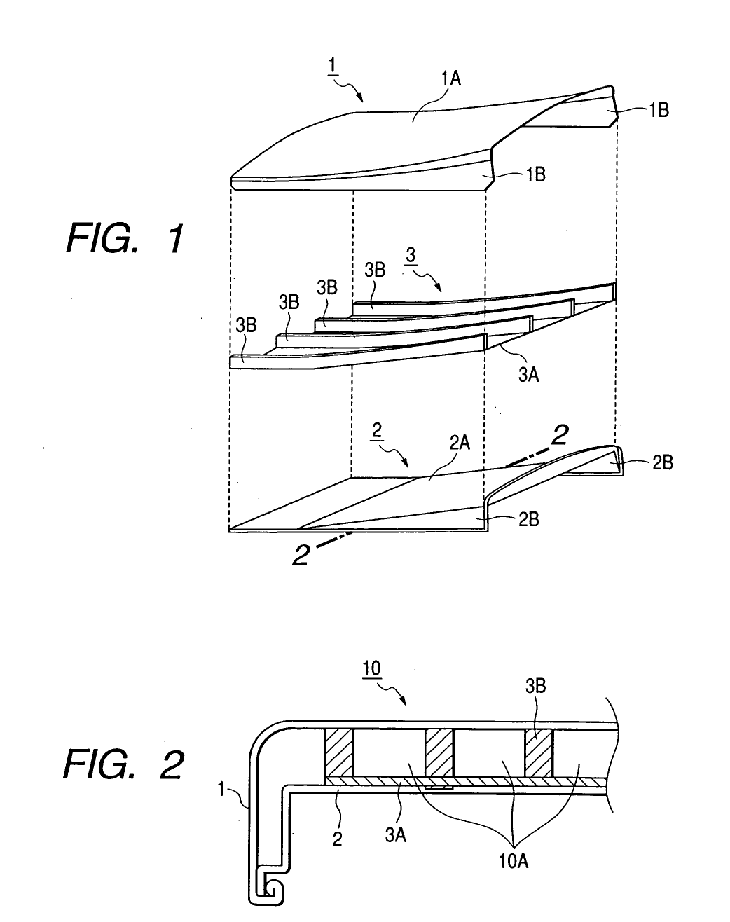

FIG. 1 is an exploded perspective view of a main portion of an armor member according to a first embodiment of the present invention. FIG. 2 is a sectional view of the armor member shown in FIG. 1 taken along the line 2-2. In the drawings, numeral 1 indicates a first armor cover member, which forms an outer side surface of the armor member of a product. The first armor cover 1 is formed by a curved surface portion 1A and side surface portions 1B. The surface portion 1A and the side surface portion 1B are formed through stamping of a single tin plate. In the drawings, numeral 2 indicates a second armor cover member, which forms an inner side surface of the armor member of the product. The second armor cover member 2 is formed by a flat portion 2A corresponding to the surface portion 1A of the first armor cover member 1 and side surface portions 2B. The flat portion 2A and the side surface portions 2B are formed through stamping of a single tin plate. In the drawings, numeral 3 indicates an intermediate member formed of a pulp material or a foamed material. The intermediate member 3 consists of a base plate member 3A and a plurality of partition members 3B provided on the surface of the base plate member 3A so as to be upright, with the base plate member 3A and the partition members 3B being fixed together by adhesive.

Note that the intermediate member 3 can be formed of a pulp material such as a cardboard made of Kraft paper, or a foamed material, such as urethane foam material, foamed polypropylene, micro-cell urethane foam, continuous polyurethane foam, and moltplane.

Further, as shown in FIG. 2, the first armor cover member 1 and the second armor cover member 2 enclose the intermediate member 3, and are assembled into an armor member 10 through a curling process described below. In this process, a plurality of space portions 10A is formed by the surface portion 1A of the first armor cover member 1 and the base plate member 3A and the partition members 3B of the intermediate member 3. Note that the intermediate member 3 has a thickness larger than the thickness of the space defined by combining the first armor member 1 and the second armor member 2, and is compressed for arrangement.

The armor member 10, in which the intermediate member 3 made of a soft member is sandwiched between the first and second armor members 1 and 2 made of hard members, is capable of exerting a sufficient vibration absorbing function.

Further, the kinetic energy of the vibration and sound transmitted to the armor member 10 is converted to heat energy by the frictional heat generated in the contact surfaces of the first and second armor cover members 1 and 2 and the intermediate member 3, whereby the armor member 10 serves to insulate vibration, sound, etc. By making the intermediate member 3 thicker than the space defined by combining the first and second armor cover members 1 and 2, the frictional force between the intermediate member 3 and the first and second armor cover members 1 and 2 increases, which also enhances the effect thereof.

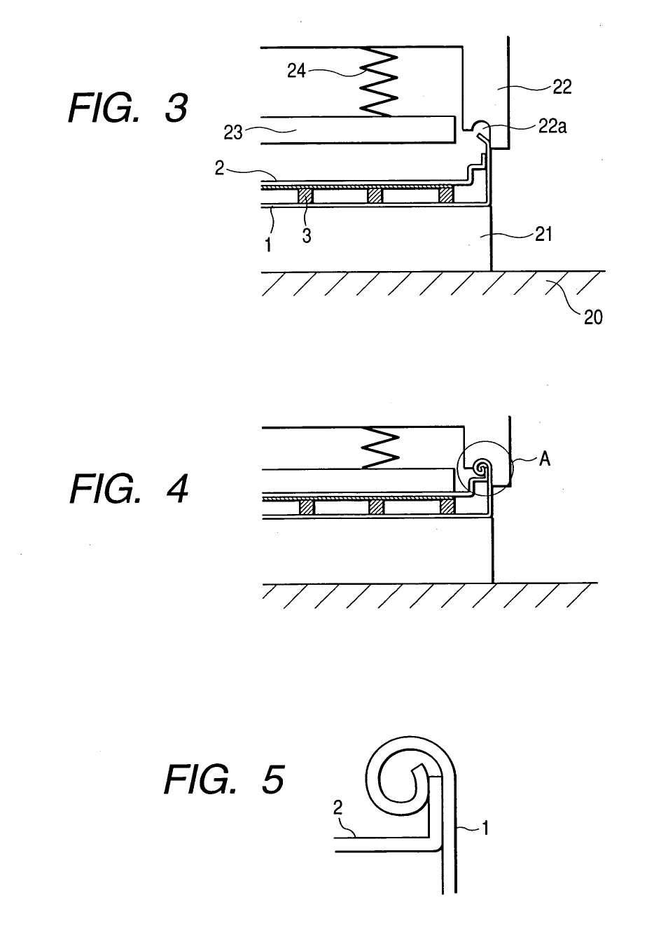

Next, the method of assembling the armor member 10 through the curling process will be illustrated with reference to FIGS. 3 through 5. FIG. 3 shows the state immediately before the curling process, and FIG. 4 shows the state during the curling process. FIG. 5 is an enlarged view of a curled portion A of the armor member 10 in FIG. 4, which shows the state during the curling process.

First, a curling apparatus will be described. In the drawings, numeral 20 indicates a fixation base, to which a lower die 21 is fixed. Numeral 22 indicates an upper die having a curling formation portion 22a at an end portion of its shaping surface. By pressurizing the upper die 22, the curling formation portion 22a shapes an end portion of the workpiece into a round, curved configuration along the curling formation portion 22a. Numeral 23 indicates a stopper member mounted to the upper die 22 through the intermediation of a spring member 24. When the upper die 22 is pressurized, the stopper member 23 serves to secure the workpiece in position to prevent it from being displaced. Due to the elastic force of the spring member 24, no pressure higher than a predetermined level is applied to portions other than the curling formation portion 22a.

Next, the procedures for assembling the armor member 10 by using the above-described curling apparatus will be described. First, the first and second armor cover members 1 and 2 are shaped into the configuration as shown in FIG. 1 through an ordinary stamping process (not shown). Further, regarding the intermediate member 3, the partition members 3B are fixed to the base plate member 3A by adhesive. Next, as shown in FIG. 3, the first armor cover member 1 obtained through stamping is arranged on the lower die 21 such that the side surface portions 1B are directed upwards. In this process, the forward end portions of the side surface portions 1B are slightly bent inwards so as to facilitate the curling process by the upper die 22. Subsequently, the intermediate member 3, made of metal the base plate member 3A and the partition members 3B glued thereto, is arranged on the first armor cover member 1 such that the base plate member 3A comes on top. Further, the second armor cover member 2 obtained through stamping is arranged from above on the intermediate member 3. The end portions of the side surface portions 2B of the second armor cover member 2 are designed so as to be fitted in so as to be in contact with the inner sides of the side surface portions 1B of the first armor cover member 1.

Next, as shown in FIG. 4, the upper die 22 is moved downwards as seen in the drawing by a drive cylinder (not shown). As a result, the stopper member 23 also descends with the descent of the upper die 22 and comes into contact with the surface portion 2A of the second armor cover member 2. However, due to the elastic force of the spring member 24, practically no pressure is applied to the surface portion 2A of the second armor cover member 2. Subsequently, when the upper die 22 descends, the forward ends of the side surface portions 1B of the first armor cover member 1 abut the curling formation portion 22a of the upper die 22, and, through further descent of the upper die 22, the forward end portions of the side surface portions 1B are curled in conformity with the curved configuration of the curling formation portions 22a. As shown in FIG. 5, in this process, the side surface portions 2B of the second armor cover member 2 are worked so as to be rolled in and sandwiched between the curved forward end portions of the side surface portions 1B and the portions that are not curled, so that the first and second armor cover members 1 and 2 are perfectly secured in position.

Next, after moving the upper die 22 upwards as seen in the drawing, the armor member 10, formed by integrating the first and second armor cover members 1 and 2 and the intermediate members 3, is extracted, with which the assembly of the armor member 10 is completed.

(Second Embodiment)

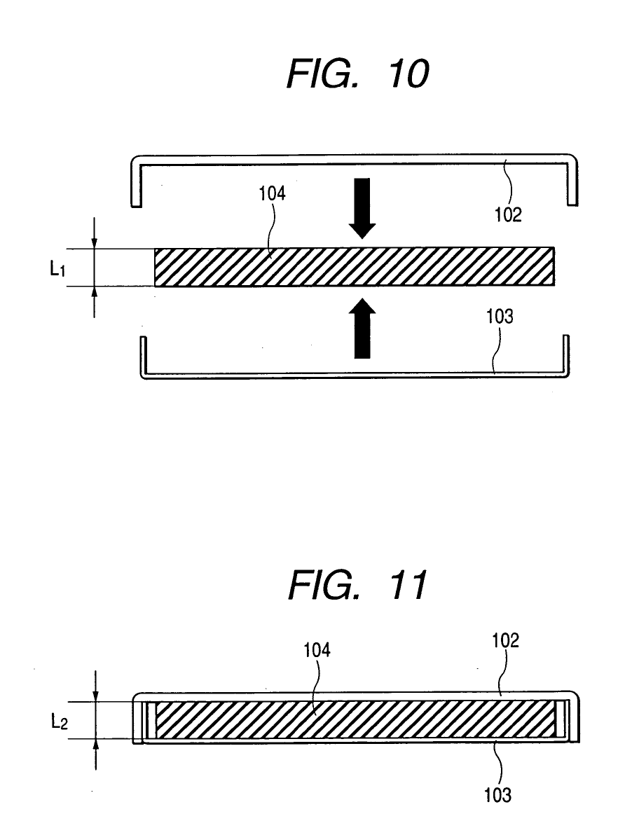

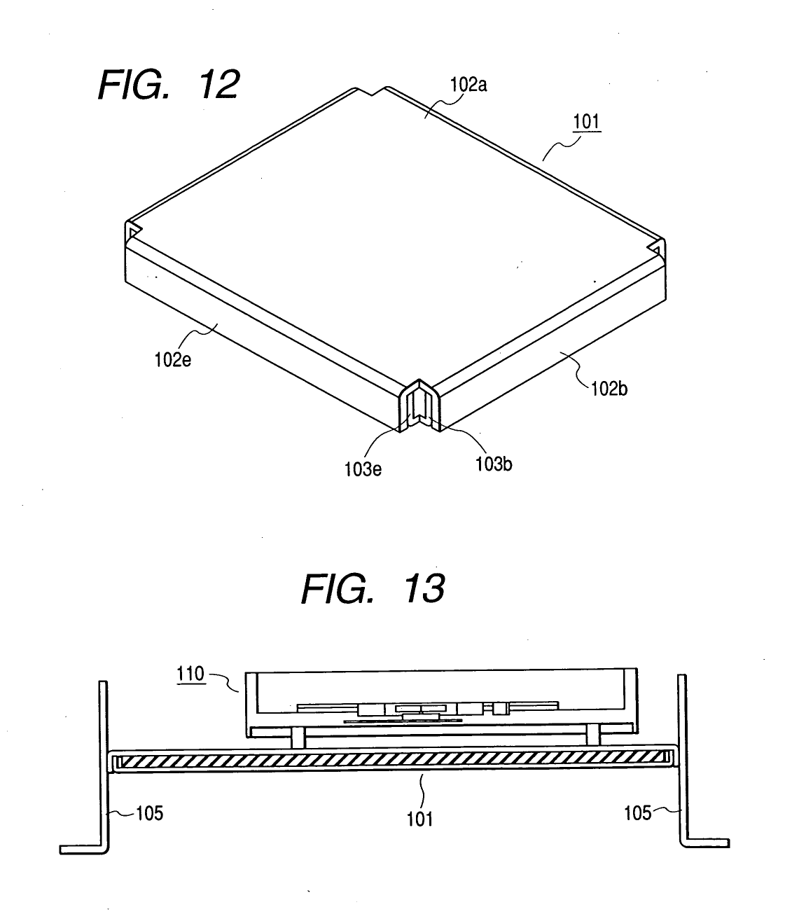

FIG. 10 is a sectional view showing a retaining member according to a second embodiment of the present invention in the state prior to assembly. FIG. 11 is a sectional view of the same in the state after the assembly, and FIG. 12 is a perspective view of the same in the state after the assembly. In the drawings, numeral 101 indicates a retaining member having a vibration absorbing function. The retaining member 101 is composed of a metal member 102, a metal member 103, and an intermediate member 104. By combining the metal members 102 and 103 through the intermediation of the intermediate member 104, the box-like retaining member 101 as shown in FIGS. 11 and 12 is obtained. The metal members 102 and 103 are fixed to each other by screw members or adhesive.

The metal member 102 is formed by bending the four peripheral sides of a metal plate, and is composed of an upper surface 102a and side surfaces 102b, 102c, 102d, and 102e. The side surfaces 102b and 102d are opposed to each other, and the side surfaces 102c and 102e are opposed to each other. Similarly, the metal member 103 is formed by bending the four peripheral sides of a metal plate, and is composed of a lower surface 103a and side surfaces 103b, 103c, 103d, and 103e. The side surfaces 103b and 103d are opposed to each other, and the side surfaces 103c and 103e are opposed to each other. In order that the contour of the metal member 103 may be enclosed in the metal member 102, the upper surface 102a of the metal member 102 is made wider than the lower surface 103a of the metal member 103 in correspondence with the thickness of the side surfaces 102b, 102c, 102d, and 102e. Note that it is also possible to make the upper surface 102a of the metal member 102 smaller than the lower surface 103a of the metal member 103 so that the contour of the metal member 102 may be enclosed in the metal member 103.

The intermediate member 104 can be formed of a pulp material such as a cardboard made of Kraft paper, or a foamed material, such as urethane foam material, foamed polypropylene, micro-cell urethane foam, continuous polyurethane foam, and moltplane. The intermediate member 104 has a thickness L1 larger than the thickness L2 of the space defined by combining the metal members 102 and 103, and is compressed between the metal members 102 and 103.

The kinetic energy of vibration, etc. transmitted to the retaining member 101 is converted to heat energy by the frictional heat generated on the contact surfaces of the metal members 102 and 103 and the intermediate member 104, whereby the retaining member 101 functions as a vibration insulator or the like. By making the thickness of the intermediate member 104 larger than the thickness of the space defined by combining the metal member 103 and the intermediate member 104, the frictional force between the metal member 103 and the intermediate member 104 increases, which leads to an enhanced effect.

Note that while in FIGS. 10 through 12 the wall thickness of the metal member 102 is larger than the wall thickness of the metal member 103, this should not be construed restrictively in this embodiment. It is also possible for the wall thickness of the metal member 103 to be larger than the wall thickness of the metal member 102. Further, it is also possible for the metal members 102 and 103 to have the same wall thickness.

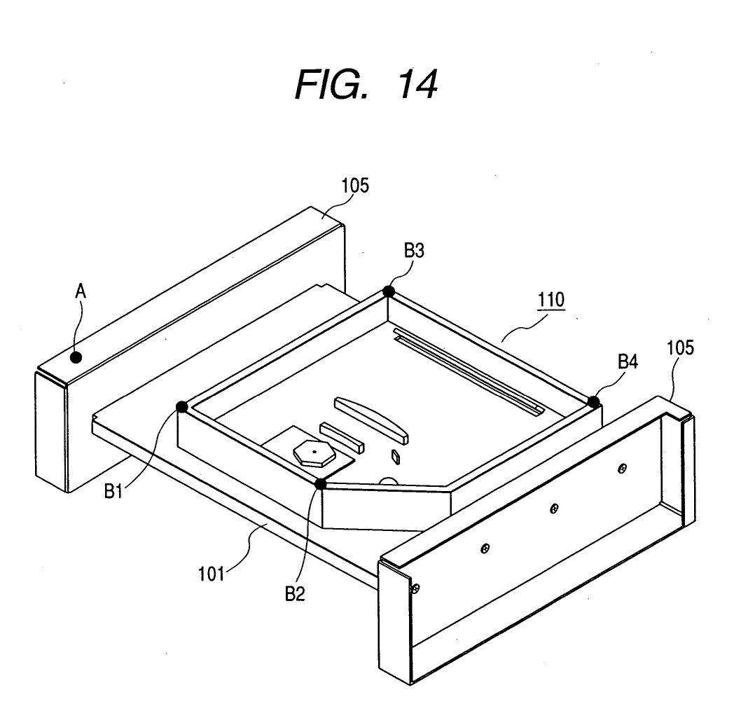

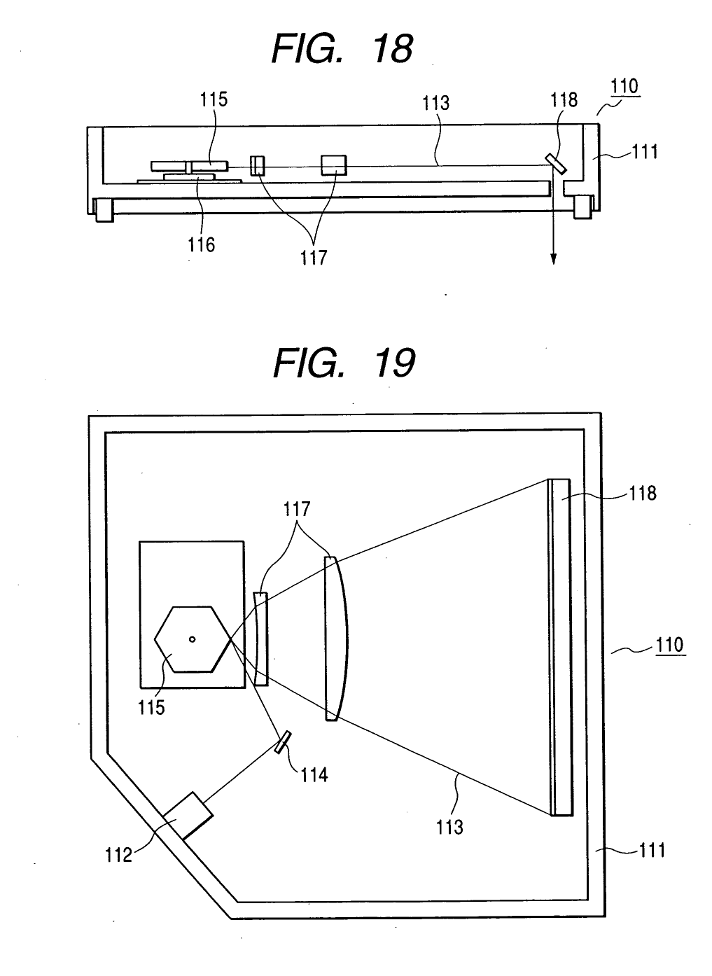

Next, FIG. 13 is a sectional view showing how a scanning optical device 110 as shown in FIGS. 18 and 19 is retained by the above-described retaining member 101. Note that in FIG. 13, the components which are the same as those of FIGS. 18 and 19 are indicated by the same reference numerals, and a description of such components will be omitted. In the drawings, numeral 105 indicates side plates of the main body of an image forming apparatus to which the retaining member 101 is mounted. The retaining member 101 is fixed to the side plates 105 by means of screws. The scanning optical device 110 is secured at a predetermined position on the retaining member 101 by means of screws or the like.

In FIG. 13, when the scanning optical device 110 is driven, a polygon motor 116 rotates at high speed to rotate a polygon 115. However, since the scanning optical device 110 is retained by the retaining member 101, the vibration of the polygon motor 116 is absorbed and reduced by the retaining member 101. The vibration energy of the polygon motor 116 is converted from kinetic energy to heat energy by the frictional heat generated on the contact surfaces of the metal members 102 and 103 and the intermediate member 104 of the retaining member 101. As a result, the vibration energy of the polygon motor 116 is absorbed by the retaining member 101 in all the frequency bands. Similarly, the vibration of a drive source in the main body of the image forming apparatus other than the scanning optical device 110′ (e.g., a transport roller or a driving motor) is absorbed by the retaining member 101, so that it is not transmitted to the scanning optical device 110.

Further, since the retaining member 101 of this embodiment can be easily disassembled into the metal members 102 and 103 and the intermediate member 104 by unscrewing or ripping off, it is superior in terms of recycling, too.

Next, specific examples as to the First Embodiment and the Second Embodiment will be described as Example 1 and Example 2, respectively.

### (EXAMPLE 1)

Next, as Example 1, an armor member (Experimental Example 1) composed of the first and second armor cover members 1 and 2 and the intermediate member 3 enclosed therein, a conventional resin armor member (Comparative Experimental Example 1), and conventional metal armor members (Comparative Experimental Examples 2 and 3) were compared with each other in terms of rigidity through simulation experiment.

In the calculation of Experimental Example 1, it was assumed that the first and second armor cover members 1 and 2 formed of tin were both 400 mm long, 600 mm wide, and 0.3 mm thick, and that the pulp intermediate member 3 formed of Kraft material (K liner) was 2.5 mm thick. Similarly, as Comparative Experimental Example 1, an armor member exclusively made of a resin member 400 mm long, 600 mm wide, and 2.5 mm thick was used, and, as Comparative Experimental Example 2, an armor member constructed of a single iron plate 1.0 mm thick was used. As Comparative Experimental Example 3, an armor member made of a metal member formed by combining two iron plates 0.35 mm and 0.5 mm thick, respectively, was adopted to conduct calculation. The rigidity of each armor member was examined from the deflection amount of an apex when a load of 0.5 kgf was applied thereto, with other three apexes constrained. The larger, the deflection amount, the lower the rigidity of the armor member, and, the smaller the deflection amount, the higher the rigidity of the armor member. Table 1 shows the results of the experiment. Table 1 also shows the weight and working cost of each armor member.

TABLE 1

| | Weight | Rigidity | Working Cost |
|---|---|---|---|
| | (kg) | (mm) | (Yen) |
| Experimental Example 1 | 1.2 | 0.38 | 580 |
| Comparative | 1.0 | 28.3 | 650 |
| Experimental Example 1 | | | |
| (resin) | | | |
| Comparative | 2.0 | 37.6 | 760 |
| Experimental Example 2 | | | |
| (single metal plate) | | | |
| Comparative | 1.7 | 0.17 | 630 |
| Experimental Example 3 | | | |
| (two metal plates) | | | |

As can be seen from Table 1, as compared with the armor member of Comparative Experimental Example 1 exclusively made of resin, the armor member of Experimental Example 1 provides much higher rigidity despite the fact that it only involves a slight increase in weight. Further, as compared with the armor member of Comparative Experimental Example 2 made of a single iron member, the armor member of Experimental Example 1 is substantially lighter in weight and much higher in rigidity. Further, as compared with the armor member of Comparative Experimental Example 3 constructed of a metal member formed by combining two metal plates, the armor member of Experimental Example 1 is somewhat lower in rigidity, but substantially lighter in weight. Further, as compared with Comparative Experimental Examples 1 through 3, the armor member of Experimental Example 1 involves a lower working cost, which proves it to be most advantageous in terms of cost.

Next, a comparison example regarding noise was performed on the armor member of Experimental Example 1 and an armor member equivalent to Comparative Experimental Example 2 and made of a single iron member having a thickness of 1.0 mm. In the experiment, the armor member of this Experimental Example 1 and the armor member of Comparative Experimental Example 2 were attached to the armor member of an actual copying machine, and the magnitude of the sound leaked to the exterior when the copying machine was operated was measured. Table 2 shows the measurement results.

TABLE 2

| | | Sound Power |
|---|---|---|
| | | (dB) |
| Experimental Example 1 | Without Seal | 68.8 |
| | With Seal | 68.3 |
| Comparative | Without Seal | 70.1 |
| Experimental Example 2 | With Seal | 70.0 |
| (single metal plate) | | |

As can be seen from Table 2, as compared with Comparative Experimental Example 2, the armor member of Experimental Example 1 is reduced in noise by 1.3 dB without seal and by 1.7 dB with seal.

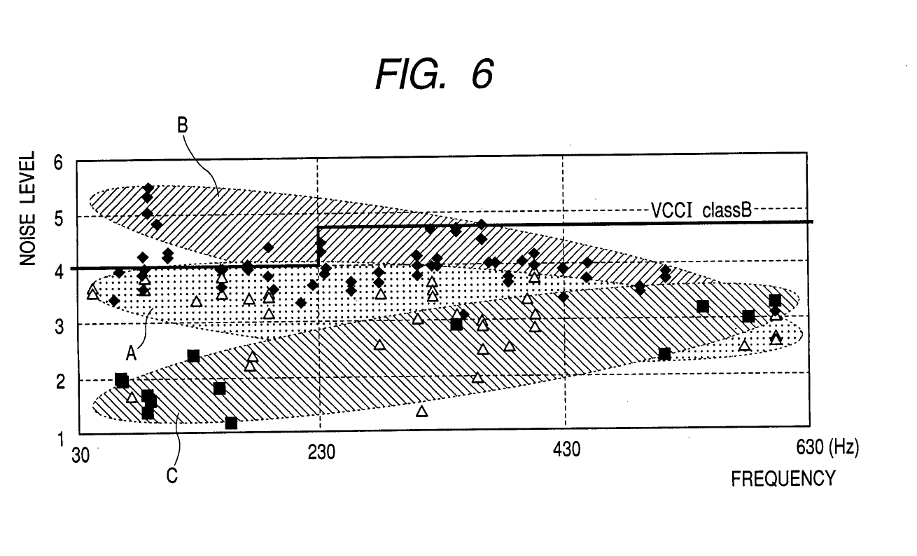

Next, a comparison experiment was performed in which the measurement of the emission amount of emitted electromagnetic wave noise at different frequencies was conducted on the armor member of Experimental Example 1, an armor member equivalent to Comparative Experimental Example 1 and made of a resin member having a thickness of 2.5 mm, and an armor member equivalent to Comparative Experimental Example 2 and made of a single iron member having a thickness of 1.0 mm. In the experiment, the armor member of Experimental Example 1 and the armor members of Comparative Experimental Examples 1 and 2 were attached to the armor member of an actual copying machine and the amount of emitted electromagnetic wave noise emitted to the exterior of the copying machine when the copying machine was operated was measured. FIG. 6 shows the measurement results. In FIG. 6, the horizontal axis indicates frequency band, and the vertical axis indicates noise level.

In FIG. 6, symbol Δ and the shaded area A indicate the measurement value region of the emission noise level from the copying machine when the armor member of Experimental Example 1 is adopted. Symbol ♦ and the shaded area B indicate the measurement value region of the emission noise level when the armor member of Comparative Example 1 made of a resin member is adopted. Symbol ▪ and the shaded area C indicate the measurement value region of the emission noise level when the armor member of Comparative Example 2 made of a metal member is adopted. In FIG. 6, the expression VCCI class B indicates the amount of emission noise presenting a problem in a product. A product involving a value exceeding this is not acceptable.

As can be seen from FIG. 6, as compared with Comparative Example 1, the armor member of Experimental Example 1 involves a smaller amount of emission noise. The tendency is conspicuous particularly in the low frequency range. Further, as compared with Comparative Example 2 made of an armor member formed of a single metal plate, it involves a somewhat larger amount of emission noise. However, the critical amount for a product, indicated by the expression VCCI class B, is not exceeded at any of the frequencies, which means it is sufficiently acceptable for practical use.

Further, a similar experiment was conducted by using, instead of the pulp intermediate member 3 of Experimental Example 1 described above, a foamed material made of foam polypropylene (Eperan PP) to obtain substantially the same experiment results.

As described above, as compared with the conventional armor members, First Embodiment makes it possible to maintain the requisite rigidity without involving an increase in weight and to reduce the requisite processing cost. Further, even if reproduced, the first and second armor cover members formed of tin allow perfect recycling without involving deterioration in performance. Further, the intermediate member formed of pulp material and foamed material, which is simply sandwiched between the first and second armor cover members, can be easily separated from the armor cover members and readily incinerated. Further, since the first and second armor cover members are formed of metal, they can easily meet the requirement regarding flame resistance. Further, the emission noise can be advantageously reduced to a level acceptable for practical use.

Note that, while in this First Embodiment, the intermediate member 3 consists of the base plate member 3A and the plurality of partition members 3B made of paper glued to the surface thereof so as to be upright, this should not be construed restrictively. It is also possible for the base plate member 3A and the partition member 3B to be formed integrally through molding. Further, it is also possible to adopt a member simply in the form of a plate. However, taking into account the cost of the pulp material and the foamed material and the weight of the entire armor member 10, it is more effective to adopt a configuration with an inner space for the armor member due to the large entire volume involved. Further, even if the armor member 10 is formed as a hollow member, there is practically no change in the rigidity of the armor member 10.

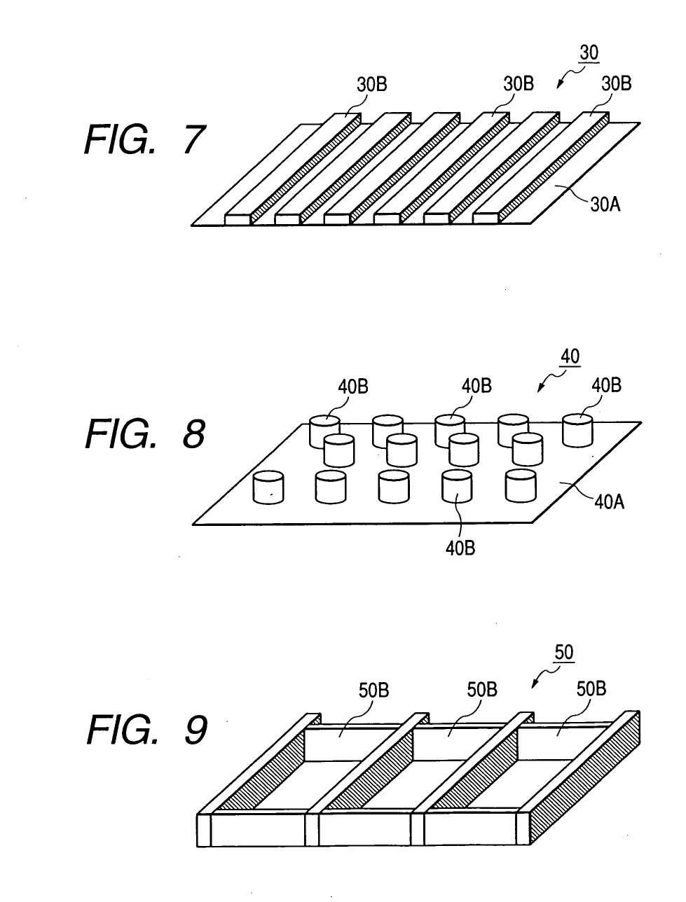

Further, as shown in FIG. 7, it is also possible to form the intermediate member 3 by gluing plate-like members 30B to a base plate member 30A at arbitrary intervals. Further, as shown in FIG. 8, it is also possible to glue a plurality of cylindrical members 40B to a base plate member 40A at arbitrary intervals. Further, as shown in FIG. 9, instead of using a base plate member, it is also possible to connect together an arbitrary number of frame members 50B or integrate them through molding.

Further, the configuration of the intermediate member as described above is to be arbitrarily selected according to the size of the armor member and the requisite strength. Further, it is to be appropriately selected according to the strength, etc. of the material used.

Further, while in this First Embodiment one intermediate member is enclosed between two metal members, this should not be construed restrictively. It is also possible to adopt a form in which two or more intermediate members are enclosed between three or more metal members.

### EXAMPLE 2

In this example, the metal member 102 was formed by working a metal plate made of a steel plate having a thickness of 1.0 mm. The metal member 103 was formed by working a metal plate made of a steel plate having a thickness of 0.5 mm. The intermediate member 104 was formed of a pulp material with contractility in the form of a plate having a thickness of 5 mm. In this case, cardboard made from a Kraft material (K liner) generally used was adopted.

First, a metal plate having a thickness of 1.0 mm was stamped into a predetermined configuration, and the four side portions of the resultant plate were bent to thereby form a metal member 2 having an upper surface 102a having a size of 450 mm×300 mm, side surfaces 102b and 102d having a size of 450 mm×6.0 mm, and side surfaces 102c and 102e having a size of 300 mm×6.0 mm. Similarly, a metal plate having a thickness of 0.5 mm was stamped into a predetermined configuration, and the four side portions of the resultant plate were bent to thereby form a metal member 3 having an upper surface 3a having a size of 448 mm×298 mm, side surfaces 3b and 3d having a size of 448 mm×5.0 mm, and side surfaces 3c and 3e having a size of 298 mm×5.0 mm. The intermediate member 4 was formed by cutting into a rectangular parallelepiped having a thickness (L1) of 5.0 mm and a size of 446 mm×296 mm. In this way, the metal member 102, the metal member 103, and the intermediate member 104 shown in FIG. 10 were prepared.

Next, the metal member 102 and the metal member 103 were combined, with the intermediate member 104 being sandwiched between them, and fixed together by screwing at three or more positions. The outer size of the retaining member 101 is 450 mm×300 mm×6.0 mm. In this case, the thickness of the gap formed by combining the metal members 102 and 103 (L2=4.5 mm) is smaller than the thickness of the intermediate member (L1=5.0 mm) by 0.5 mm. Thus, the intermediate member 104 was arranged in the gap defined by combining the metal members 102 and 103 while being compressed at the time of assembly. In this way, the retaining member 101 as shown in FIGS. 11 and 12 was formed.

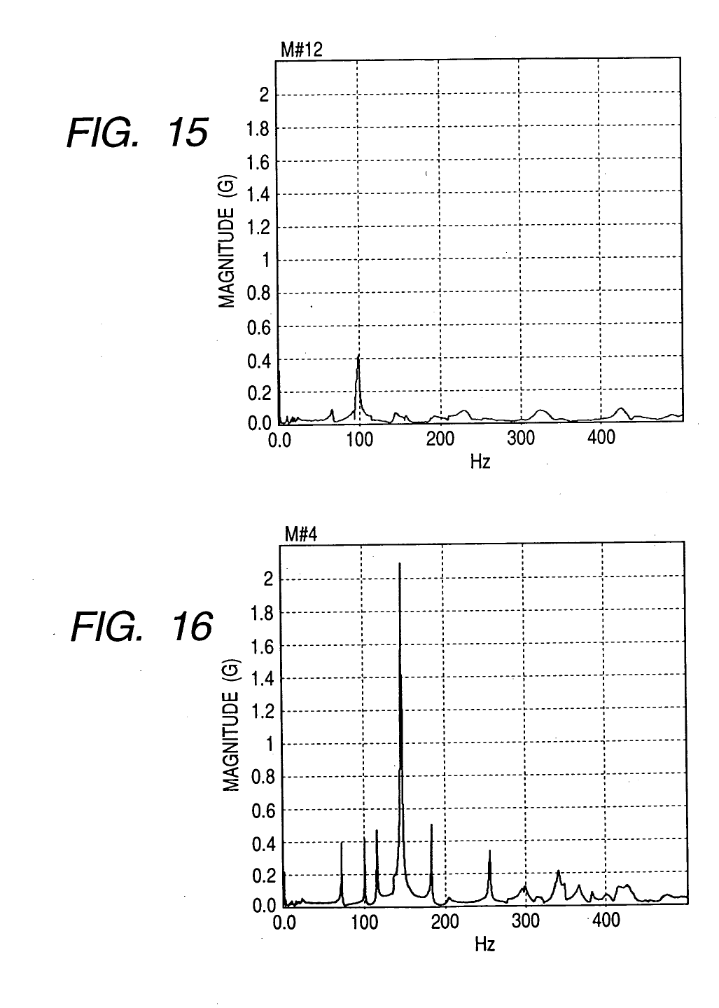

Next, to measure the vibration absorbing characteristics of the retaining member 101, the following experiment was conducted as Experimental Example 2. FIG. 14 is a perspective view showing the way the experiment was conducted. In FIG. 14, the retaining member 101 was supported by the side plates 105. The scanning optical device 110 is fixed at a predetermined position on the retaining member 101 by means of screws. In this state, a sensor was installed at each measurement point. By using a vibrator, a vibration of 40 N was imparted once to a predetermined point A at an end portion of the upper surface of one side plate 105. The corner portions of the upper end of the case 111 of the scanning optical device 110 were used as measurement points B1 to B2, and the magnitude at the moment when vibration is applied to each measurement point was measured by an magnitude sensor. This procedure was repeated five times to obtain the average value. FIG. 15 shows the measurement result obtained regarding point B1. In FIG. 15, the X-axis indicates frequency (Hz), and the Y-axis indicates magnitude (G) at the measurement the point B1.

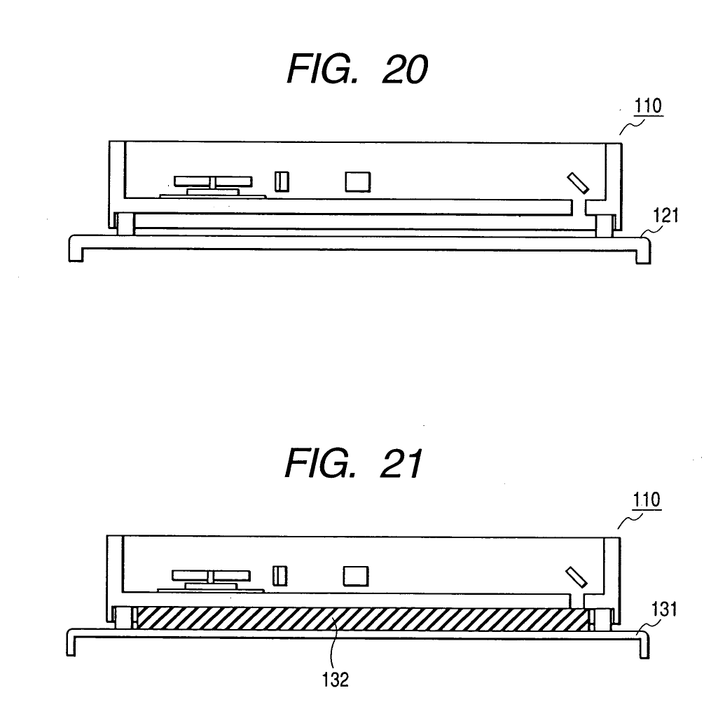

Further, for comparison, an experiment similar to Experimental Example 2 was conducted on a retaining member 121 shown in FIG. 20 as Comparative Experimental Example 4. Here, the retaining member 121 is a metal member made of a steel plate having a size of 450 mm×300 mm, a thickness of 2 mm, and a bent-portion length of 6.5 mm. FIG. 16 shows the experiment results.

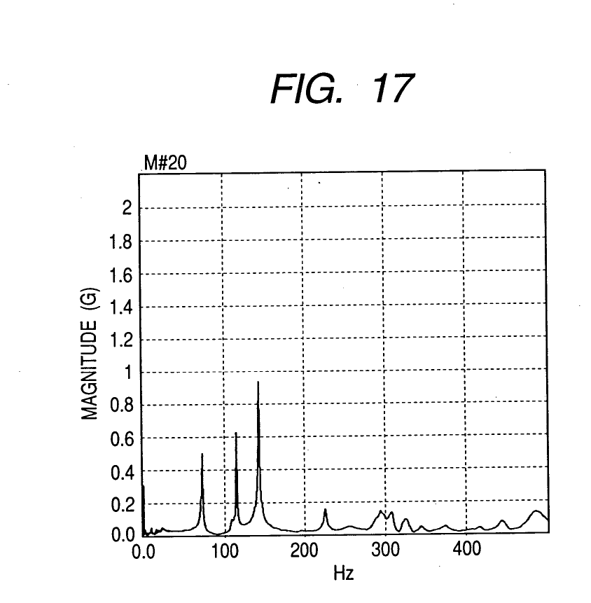

Similarly, an experiment similar to Experimental Example 2 was conducted on a retaining member 131 with a vibration-insulating member 132 attached thereto shown in FIG. 21 as Comparative Experimental Example 5. The retaining member 131 is a metal member made of a steel plate having a size of 450 mm×300 mm, a thickness of 2 mm, and a bent-portion length of 6.5 mm, and the vibration-insulating member 132 is a polyethylene foam member having a size of 450 mm×300 mm, and a thickness of 5 mm. The vibration-insulating member 132 is sandwiched between the retaining member 131 and the scanning optical device 110 in a compressed state. FIG. 17 shows the experiment result.

Generally speaking, a retaining member for retaining a scanning optical device is required to have vibration absorbing characteristics such that it exhibits a magnitude of 0.5 G or less at a frequency ranging from 100 Hz to 400 Hz. When the magnitude is more than 0.5 G, the image formed by the scanning optical device will be blurred. In Experimental Example 1 shown in FIG. 15, the magnitude is below 0.5 G at all frequencies, which indicates that the retaining member 101 has a very satisfactory vibration absorbing characteristics. In contrast, in Comparative Experimental Example 4 shown in FIG. 16, this value is exceeded at frequency levels near 120 Hz and 150 Hz. That is, the retaining member 121 of Comparative Example 4 and the retaining member 131 and the vibration insulating member 132 of Comparative Experimental Example 5 do not provide a sufficient vibration absorbing function, with the result that the image formed by the scanning optical device is blurred.

Further, a similar experiment was conducted by using, instead of the intermediate member 104 of Example 2 formed of a pulp material, a foamed material consisting of foam polypropylene (Eperan PP). The experiment results obtained were substantially the same as those described above.

As described above, in accordance with the Second Embodiment, it is possible to achieve quality assurance regarding strength, vibration insulation, etc. without involving an increase in the weight of the retaining member. Further, due to its very simple construction, the retaining member is very easy to produce, making it possible to achieve a substantial reduction in production cost. Further, the member readily allows recycling.

Further, while in the Second Embodiment the intermediate member 104 consists of a plate-like intermediate member, this should not be construed restrictively. As in the First Embodiment, the intermediate member may have a configuration containing an inner space. However, as compared with the armor member, the retaining member has a smaller volume, so that there is little need to take into account the cost of the pulp material and the weight. In view of the frictional force between the metal members 102 and 103 is taken into consideration, a solid intermediate member will be more effective.

As described above, in accordance with the present invention, there is provided an armor member formed by sandwiching between a plurality of metal members an intermediate member formed of a pulp material or a foamed material. Unlike the conventional armor members, the armor member of the present invention makes it possible to maintain the requisite rigidity without involving an increase in weight. Further, it is also possible to achieve a reduction in processing cost.

Further, the intermediate member is composed of a base plate member and a plurality of partition members provided thereon, with the plurality of partition members forming hollow portions between the plurality of metal members, whereby it is possible to achieve a reduction in noise while maintaining the requisite rigidity.

Further, the metal members do not suffer deterioration in performance upon recycling. Further, the intermediate member, which is formed of pulp, can be easily incinerated. Further, the forward end portions of the metal members are rolled up for fixation through the curling process, and the intermediate member is simply held between the two metal members, so that the intermediate member formed of pulp can be easily separated from the metal members, thus providing a structure which is very suitable for recycling.

Further, since the first and second armor cover members are formed of metal, the requirement regarding flame resistance can be easily met.

Further, when the armor member of the present invention is applied to an image forming apparatus, it is possible to reduce the emission noise from within the apparatus to a level presenting no problem for practical use.

Further, in accordance with the present invention, with the simple construction in which an intermediate member of a pulp material or a foamed material is simply arranged between a plurality of metal members, it is possible to obtain a retaining member providing a high level of vibration attenuating effect. Further, since no increase in the thickness and weight of the retaining member is involved, there is no serious obstruction regarding the design of the image forming apparatus, and the handling in production is very easy.

Further, since there is no need to arrange or insert some other component at the time of assembly, the production process is very easy to perform, making it possible to achieve a reduction in production cost. Further, there are no limitations regarding the layout of other components, which is very advantageous from the viewpoint of product design.

Further, the product can be easily dismantled by unscrewing or ripping off, which is very advantageous from the viewpoint of recycling.

1. An armor member used for an image forming apparatus, comprising:
two metal members; and
an intermediate member formed of a pulp material or a foamed material,
wherein the intermediate member is sandwiched between the metal members, and comprises a base plate member and a plurality of partition members provided on the base plate member, with the base plate member and the partition members defining a plurality of hollow portions between the metal members.

2. (canceled)

3. The armor member according to claim 1, wherein the intermediate member is formed by at least one frame member.

4. The armor member according to claim 1, wherein the metal members have a thickness of 0.3 mm or more.

5. The armor member according to claim 1, wherein one of the two metal members has at an end portion thereof a bent portion, and is fixed to the other metal member by performing a curling process on the bent portion.

6. (canceled)

7. A retaining member for retaining a component having a drive source, comprising:
two metal members; and
an intermediate member formed of a pulp material or a foamed material,
wherein the intermediate member is sandwiched between the metal members.

8. The retaining member according to claim 7, wherein the intermediate member has a thickness of ⅕ mm or more larger than a thickness of a space defined by the metal members, and is sandwiched between said metal members in a compressed state.

9. (canceled)

10. The retaining member according to claim 7, wherein the component having a drive source is a scanning optical device used for an image forming apparatus.
